(19) United States
(12) Patent Application Publication
(10) Pub. No.: US 2026/0044948 A1
(43) Pub. Date: Feb. 12, 2026

(54) EVALUATION OF LINEARITY IN CRITICAL DIMENSION MEASUREMENTS

(71) Applicant: KLA CORPORATION, Milpitas, CA (US)

(72) Inventors: Rishabh Singh Kushwaha, Milpitas, CA (US); Arjun Hegde, Milpitas, CA (US); Ramakanth Ramini, Newark, CA (US); Arpit Jain, Santa Clara, CA (US)

(21) Appl. No.: 18/796,238

(22) Filed: Aug. 6, 2024

(51) Int. Cl. G06T 7/00; G06T 5/70

(52) U.S. Cl. CPC G06T 7/001; G06T 5/70; G06T 2207/10061; G06T 2207/30148

(57) ABSTRACT

A Gaussian transfer function is applied to a profile of a feature on an image of a workpiece generated using an electron beam metrology tool. This generates an output profile. Non-linearity of the output profile is determined. Two threshold values can be selected and plotted on an XY plane. Proximity of a slope of the threshold values to a comparison value is determined.

### FIELD OF THE DISCLOSURE

This disclosure relates to workpiece metrology and, more particularly, to workpiece metrology using an electron beam.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

Metrology processes are used at various steps during semiconductor manufacturing to monitor and control the process. Metrology processes are different than inspection processes in that, unlike inspection processes in which defects are detected on workpieces, such as semiconductor wafers, metrology processes are used to measure one or more characteristics of the workpieces that cannot be determined using existing inspection tools. Metrology processes can be used to measure one or more characteristics of workpieces such that the performance of a process can be determined from the one or more characteristics. For example, metrology processes can measure a dimension (e.g., line width, thickness, etc.) of features formed on the workpieces during the process. In addition, if the one or more characteristics of the workpieces are unacceptable (e.g., out of a predetermined range for the characteristic(s)), the measurements of the one or more characteristics of the workpieces may be used to alter one or more parameters of the process such that additional workpieces manufactured by the process have acceptable characteristic(s).

Reference critical dimension (CD) measurement data can be collected on a critical dimension scanning electron microscope (CD-SEM) tool. A CD-SEM tends to be highly accurate in measuring the critical dimensions of features due to smaller beam spot size, but also can have a low throughput. High throughput tools often operate with a larger beam current and, hence, have a larger beam spot size. As a result, measurement values from a CD-SEM may not match values from other high throughput tools because of different gray level profiles caused by different beam spot sizes and additional algorithm factors. Improved systems and techniques are needed.

### BRIEF SUMMARY OF THE DISCLOSURE

A method is provided in a first embodiment. The method includes receiving, at a processor, a profile of a feature on an image of a workpiece generated using an electron beam metrology tool. The feature is less than an entirety of the workpiece. A Gaussian transfer function is applied to the profile using the processor to generate an output profile. Non-linearity of the output profile is then determined using the processor. The electron beam metrology tool may be a scanning electron microscope. The workpiece may be a semiconductor wafer.

The method can include using the electron beam metrology tool to image the workpiece and generate the image.

The determining may include comparing the adjusted profile a baseline. The determining also may include selecting two threshold values, plotting the two threshold values on an XY plane, and determining proximity of a slope of the threshold values to a comparison value. The comparison value can be equal to one. Gaussian blur in the image can be increased to increase correlation between the slope and the comparison value. Gaussian blur in the image can be reduced to increase the proximity.

A non-transitory computer readable medium can store a program configured to instruct the processor to execute an embodiment of the method.

An electron beam metrology tool is provided in a second embodiment. The electron beam metrology tool includes an electron beam source that generates an electron beam; a stage configured to hold a workpiece in a path of the electron beam; a detector that receives electrons from the workpiece; and a processor in electronic communication with the detector. The processor is configured to generate an image of a feature on the workpiece using information from the detector. The feature is less than an entirety of the workpiece. A profile of the feature in the image is generated. A Gaussian transfer function is applied to the profile thereby generating an output profile. Non-linearity of the output profile is determined. The electron beam metrology tool may be a scanning electron microscope. The workpiece may be a semiconductor wafer.

Determining the non-linearity may include comparing the adjusted profile a baseline. Determining the non-linearity also may include selecting two threshold values, plotting the two threshold values on an XY plane, and determining proximity of a slope of the threshold values to a comparison value. The comparison value can be equal to one. Gaussian blur in the image can be increased to increase correlation between the slope and the comparison value. Gaussian blur in the image can be reduced to increase the proximity.

The processor may be configured to send instructions to increase Gaussian blur in the image to increase correlation between the slope and the comparison value. The processor may be further configured to send instructions to reduce Gaussian blur in the image to increase the proximity.

### DESCRIPTION OF THE DRAWINGS

For a fuller understanding of the nature and objects of the disclosure, reference should be made to the following detailed description taken in conjunction with the accompanying drawings, in which:

FIG. 1 is a chart comparing gray level intensity for the images of a same structure, wherein one image is an CD-SEM image (CDSEM) and the other is from another electron beam metrology tool (eSL10);

FIG. 2A is a profile of an exemplary feature as printed;

FIG. 2B is a profile of the image of FIG. 2A as measured by a scanning electron microscope (SEM);

FIG. 2C is a profile of the image of FIG. 2B after a Gaussian blur is applied;

FIG. 3A shows an output profile that remains parallel with changing input and a change in output that is the same as the input;

FIG. 3B shows that as the input becomes thinner and that the output profile is not parallel.

FIG. 4A is a chart showing different amounts of Gaussian blur at a constant edge placement threshold;

FIG. 4B is a chart showing different edge placement thresholds at a constant Gaussian blur;

FIG. 5 is a flowchart of an embodiment of a method in accordance with the present disclosure; and

FIG. 6 is an exemplary electron beam metrology tool.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Semiconductor manufacturers evaluate metrology tool specifications by matching the tool's measurement data with the CD-SEM baseline data. Measured data may need to follow a linear relationship with the baseline data. However, the lower beam resolution in high-throughput metrology tools compared to CD-SEM tool reduces its sensitivity, which causes non-linear behavior. There may be a disparity in gray-level profiles in different critical dimension values for CD-SEM and another electron beam metrology tool.

Sensitivity of metrology measurements can be used when comparing the performance of multiple metrology tools. Sensitivity refers to the ability of a metrology tool to accurately measure the variability in input stimuli such that a user can estimate the changes in input from changes in output. Quantitatively, sensitivity can be defined as the slope of the plot of response versus input stimuli. In general, a linear relationship between response and input stimuli means that a scale adjustment can be applied to match measured data with input data. A study of linearity was used to evaluate measurement performance by semiconductor manufacturers.

An objective of this study was to understand how critical dimension measurements are affected by spot size and Gaussian blur, which are parameters used in an edge detection algorithm. In the study, critical dimension measurements were compared to CD-SEM data to validate results with a ground truth. The results of this study indicated that the CD-SEM data and the other data matched, indicating that correct and accurate critical dimension measurements can be performed using an embodiment of this method.

Embodiments disclosed herein can achieve linear behavior in measurements over a wider measurement range and identify if the measurements are non-linear. Blur sigma used in edge detection can be tuned to improve sensitivity for critical dimension measurement. Sensitivity of critical dimension measurements (e.g., linespace, contact critical dimension, or distance) may depend on the edge placement threshold. The edge placement threshold can be used to identify non-linearity in measurement. Numerical simulation results demonstrate the effectiveness of the disclosed embodiments and the resulting improvement of the measurement sensitivity. Reference data will be denoted by “input” and measured data (from a high throughput tool) will be denoted by “output” herein.

Critical dimension is measured using a threshold-based method. Edge points are placed where the gray level intensity matches the gray level calculated by the edge placement threshold. Edges are defined as a region in an image where there is a sudden change in the gray level value. Edge points can be defined by a user. An edge detection algorithm detects those edge points. Edge point can be any number from 0 to 100. 0 refers to a bottom of gray level profile and 100 refers to a top of gray level profile. A distance between the two edge points is measured. This distance is the critical dimension. Thus, X-distance (or Y-distance in case of horizontal features) between the two edges is the critical dimension of the feature. Regarding the edge placement threshold, a user can define these edge points by threshold. Typically, a threshold of 50 provides sufficient precision.

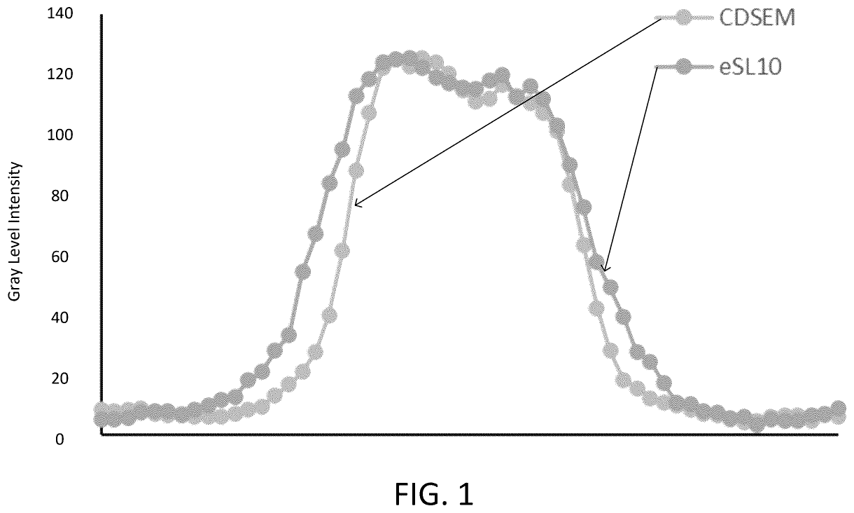

Beam spot size is the measure of the spread of the beam. Beam spot size can affect gray level profiles of features in a measurement image. Based on the landing energy and beam current, intensity distribution can be approximated by a Gaussian function s(x). A cross-section of an electron beam follows a Gaussian distribution, which means that a center of the beam has high electron density. The density reduces father from the center. A spot size of the beam is the measure of the spread of that electron beam. A higher beam current has a larger spread and, therefore, has a bigger spot size. Increasing a landing energy reduces the spot size of the beam. These parameters may be assumed as remaining constant. Some differences in beam spot size or other parameters can be seen in the results in FIG. 1.

Critical dimension measurement algorithms also may involve edge detection using traditional gray level profile analysis. The profile analysis may include noise reduction, gradient computation, min-max suppression, and/or thresholding followed by locating the edges. A Gaussian blur can be applied to reduce noise in edges and facilitate edge detection. This Gaussian blur is a mathematical function that can blur an image, which generally reduces detail or noise. The Gaussian blur also can affect gray level profiles of features in a measurement image. A Gaussian filter, g(x), may be applied on a measurement image to facilitate edge detection, which can generate the profile used for measurement. A user can tune Gaussian blur during recipe setup.

A transfer function (F(x)) can be applied on the input so it can be written as a convolution of beam spot (s(x)) and Gaussian blur (g(x)) functions.

$$F ( x ) = s ( x ) * g ( x )$$

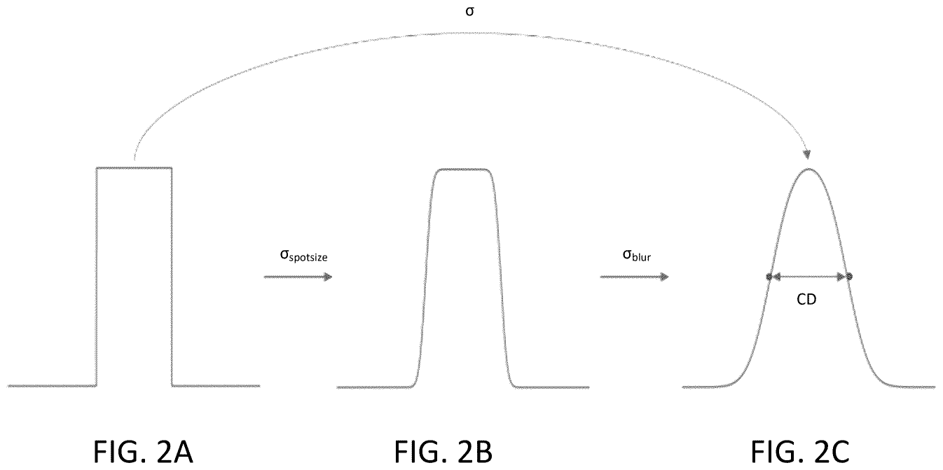

As a convolution of two Gaussian functions is also Gaussian, the transfer function, F(x) can be assumed to be another Gaussian. A response profile is determined when the transfer function is applied on input stimulus. This response profile is then used for CD measurement. The differences between these steps can be seen in FIGS. 2A-2C. In FIG. 2C, CD is the thickness at a particular edge placement threshold measured in this step.

A gray level profile, GL(x), is used for edge detection.

$$GL ( x ) = F ( x ) * CD ( x )$$

$$F ( x ) = \frac{1}{\sqrt{2 π {σ}^{2}}} {e}^{- \frac{{x}^{2}}{{σ}^{2}}}$$

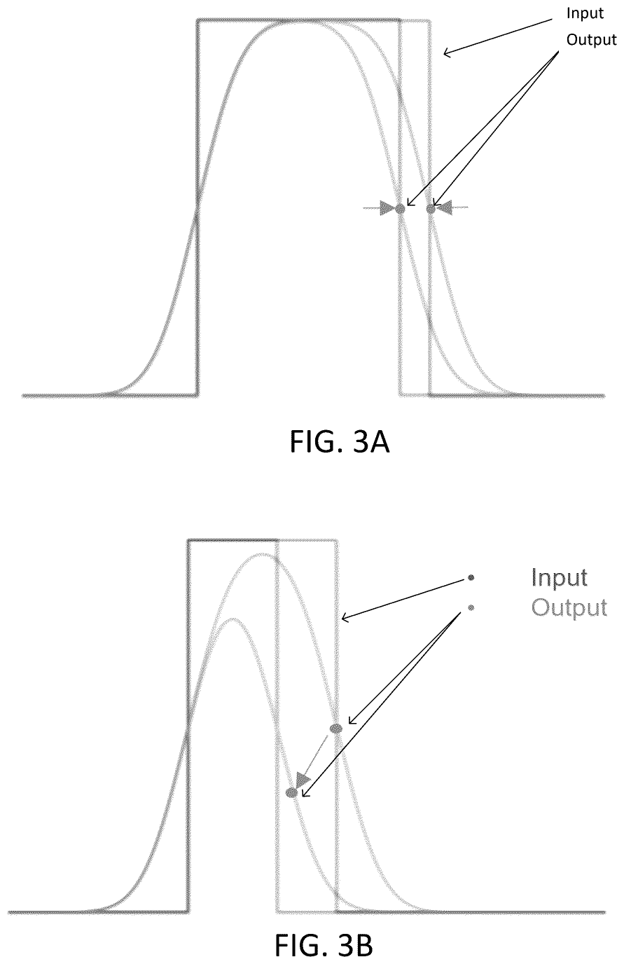

σ represents the spread of the Gaussian distribution, which can be considered a measure of the spot size of an electron beam. σ in F(x) has contributions from Gaussian blur and spot size, which is shown in FIG. 3A and FIG. 3B. FIG. 3A shows the output based on the input. If the input is wide enough, then the output will be accurate. Thus, if the critical dimension is larger than a value, then the output will be accurate. If it is accurate, then a change in measurement will correspond to a change in the actual measured value of the feature. If the critical dimension is smaller than a value, then FIG. 3B shows a difference in the measured value is shown with the arrow between the two lines. In FIG. 3B, the change in input is larger than the change in output, which indicates sensitivity loss. CD (x) is the input critical dimension profile.

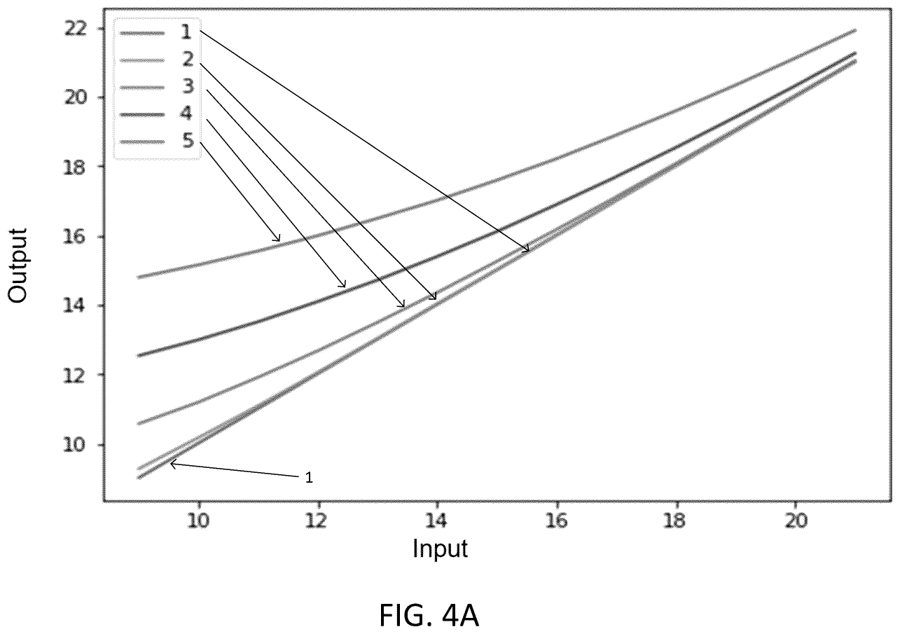

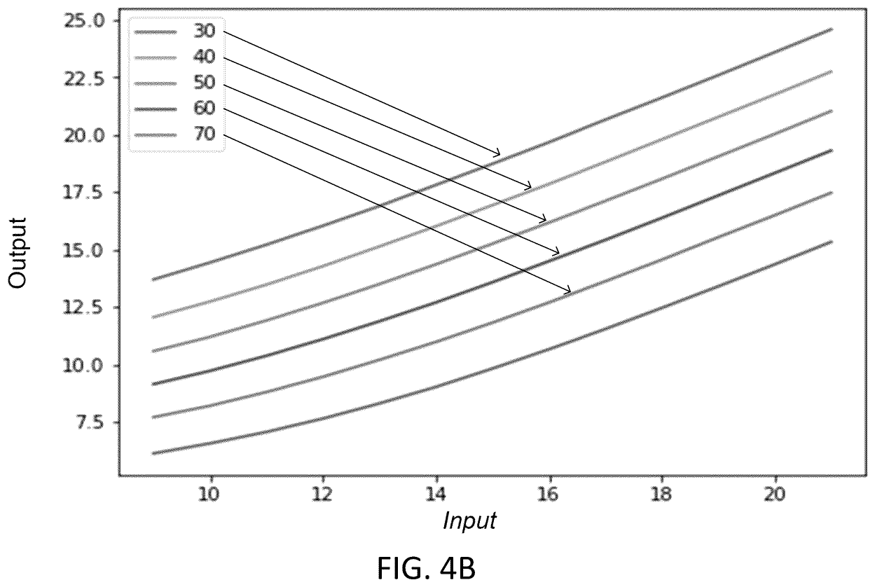

A Gaussian transfer function can be used to simulate the output response profile for a given input. Different critical dimensions have different sensitivity even when the beam spot size and Gaussian blur applied are kept constant. As shown in FIGS. 4A-4B, a plot of output (CD) versus input (CD) shows that the slope is not constant for thinner inputs. However, the slope converges to a constant value of approximately one as the input CD becomes larger. Therefore, a non-linear region is expected before entering a linear region in the output CD versus input CD plot.

A simulation shows how the output (CD) changes over a range of input (CD) with different values of Gaussian blur and edge placement threshold. This is shown in FIGS. 4A and 4B. The different trendlines of FIG. 4A indicate output (measured CD) versus input (actual CD) for different edge detection sigma (Gaussian blur). The different trendlines of FIG. 4B indicate output (measured CD) versus input (actual CD) for edge placement threshold.

FIG. 4B is consistent with predictions from FIGS. 3A-3B. A non-linearity for smaller inputs is demonstrated, which converges to linearity (slope=1) for larger critical dimension inputs. FIG. 4B shows that average slope over the measurement range is different for different threshold values. This behavior can be used to determine the accuracy of measurement data.

In an example, two slightly different threshold values are measured, such as 35% and 65%. The two threshold values are plotted on an XY plane. If the slope is close to 1, then the results are accurate. Gaussian blur can be increased to improve a correlation coefficient. If a slope is not close to approximately 1, then the results are inaccurate. Gaussian blur should be further reduced to improve accuracy.

A user can select one or more thresholds. Two thresholds may be selected. There may be one threshold on the lower end (<40) and another at the higher end (>60). Extreme values close to 0 or 100 may be avoided in certain instances. Ideally, an output versus input curve is linear for all threshold values. However, due to spot size and edge detection sigma, linearity may be lost for smaller critical dimensions. If measurements are linear, measurement of both thresholds when plotted on XY also show linearity else it would show non-linearity and a slope of the plot will be different from 1. The spot size and Gaussian blur (sigma) may be chosen in such a way that the non-linear regime is avoided.

In the examples disclosed herein, images were grabbed using 1 keV and 1 nA beam using pixel size of 0.88 nm and compared with images from a CD-SEM tool. The same landing energy and pixel size was used in the CD-SEM images, but the beam current was 7 pA (i.e., approximately ˜130 times smaller than other images).

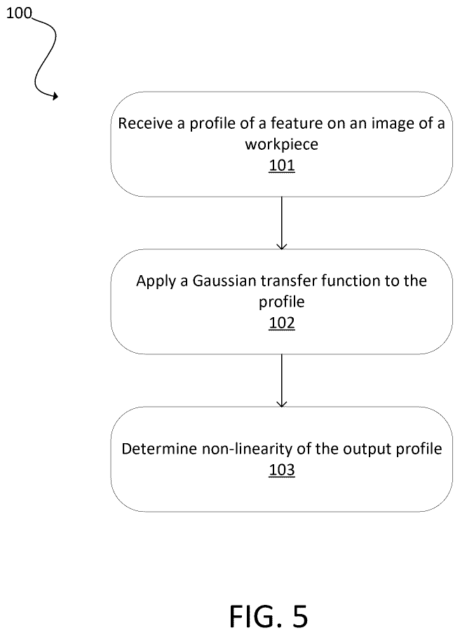

In an embodiment, FIG. 5 shows a flowchart for a method 100 implementing these teachings. A profile of a feature on an image of a workpiece (e.g., a semiconductor wafer) generated using an electron beam metrology tool (e.g., a SEM) is received at a processor at 101. The feature is less than an entirety of the workpiece. The workpiece can be imaged using the electron beam metrology tool, the resulting data of which can be used to generate the image. A Gaussian transfer function is applied to the profile using the processor thereby generating an output profile at 102. Non-linearity of the output profile is then determined using the processor at 103. A linear relationship between output profile and a baseline means that a scale adjustment can be applied to match measured data with input data. In an example, the baseline was collected on a CD-SEM tool having a spot size which is an order of magnitude smaller than high throughput critical dimension uniformity tools.

Determining the non-linearity can include comparing the adjusted profile a baseline. Determining the non-linearity also can include selecting two threshold values; plotting the two threshold values on an XY plane; and determining proximity of a slope of the threshold values to a comparison value. To determine a comparison value, the critical dimension is measured at different edge placement thresholds and the values are compared. In an instance, the comparison value should be equal to one. In another instance, Gaussian blur in the image can be reduced to increase the proximity. Performing measurements at two different thresholds and plotting those measurements on an XY plane may be used to determine the proximity of slope of the measurements at different slopes relative to a comparison value. Linearity can improve as the amount of blur is reduced. However, reducing the blur too much can worsen precision. Therefore, a lowest amount of blur that meets a precision specification may be selected.

Thus, the slope of output (i.e., measured critical dimension) versus input (AvgCD_CDSEM) gradually converges to 1 as input is made larger. AvgCD_CDSEM refers to the actual critical dimension (average critical dimension) of a feature on the semiconductor wafer. This feature is measured using an electron beam metrology tool. A critical input where the slope becomes 1 can depend upon the sigma of transfer function. A higher sigma means larger input and vice-versa.

In an example, the electron beam metrology tool measurement value is larger than CD-SEM values. The slope dropped as Gaussian blur (sigma) increased. A lower slope means that a user is operating at a non-linear region. A slope was almost constant for all threshold values if operating in a linear region. The slope reduced as threshold is increased in the non-linear region. A slope of the curve converges to 1 and any difference between the electron beam metrology tool and CD-SEM measurement would remain constant thereafter. Consequently, measurement values can be calibrated by subtracting this constant to match the CD-SEM result. The electron beam metrology tool of FIG. 1 can statistically match the measurement results of the CD-SEM tool of FIG. 1 with a slope (sensitivity) of one and an offset of zero.

The constant can be determined by comparing the results from ground truth data. To match the exact data, the ground truth may be used during recipe setup to calibrate measurement data.

Spot size (e.g., resolution) of a beam is a factor which may impact linearity in measurement results. Higher beam currents give a high signal-to-noise ratio, but may result in non-linearity in measurements due to large spot size and vice versa.

Gaussian blurring in edge detection is another factor which may impact linearity in measurement. Using a high blur for edge detection can be similar to having a beam of large spot size. Increasing blur may help reduce noise, but may add non-linearity in measurement data.

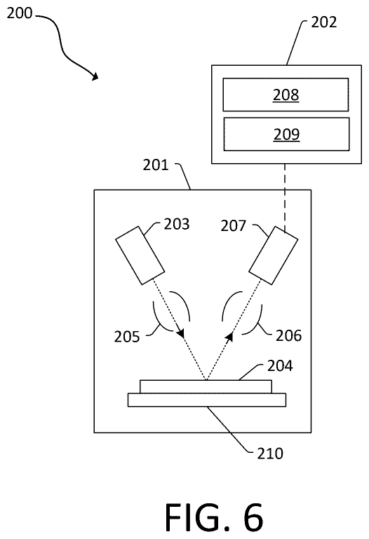

FIG. 6 is a block diagram of an embodiment of a system 200. The system 200 includes a wafer metrology tool (which includes the electron column 201) configured to generate images of a workpiece 204, which may be a semiconductor wafer.

The wafer metrology tool includes an output acquisition subsystem that includes at least an energy source and a detector. The output acquisition subsystem may be an electron beam-based output acquisition subsystem. For example, in one embodiment, the energy directed to the workpiece 204 includes electrons, and the energy detected from the workpiece 204 includes electrons. In this manner, the energy source may be an electron beam source. In one such embodiment shown in FIG. 6, the output acquisition subsystem includes electron column 201, which is coupled to computer subsystem 202. A stage 210 may hold the workpiece 204.

As also shown in FIG. 6, the electron column 201 includes an electron beam source 203 configured to generate electrons that are focused to workpiece 204 by one or more elements 205. The electron beam source 203 may include, for example, a cathode source or emitter tip. The one or more elements 205 may include, for example, a gun lens, an anode, a beam limiting aperture, a gate valve, a beam current selection aperture, an objective lens, and a scanning subsystem, all of which may include any such suitable elements known in the art.

Electrons returned from the workpiece 204 (e.g., secondary electrons) may be focused by one or more elements 206 to detector 207. One or more elements 206 may include, for example, a scanning subsystem, which may be the same scanning subsystem included in element(s) 205.

The electron column 201 also may include any other suitable elements known in the art.

Although the electron column 201 is shown in FIG. 6 as being configured such that the electrons are directed to the workpiece 204 at an oblique angle of incidence and are scattered from the workpiece 204 at another oblique angle, the electron beam may be directed to and scattered from the workpiece 204 at any suitable angles. In addition, the electron beam-based output acquisition subsystem may be configured to use multiple modes to generate images of the workpiece 204 (e.g., with different illumination angles, collection angles, etc.). The multiple modes of the electron beam-based output acquisition subsystem may be different in any image generation parameters of the output acquisition subsystem.

Computer subsystem 202 may be coupled to detector 207 as described above. The detector 207 may detect electrons returned from the surface of the workpiece 204 thereby forming electron beam images of the workpiece 204. The electron beam images may include any suitable electron beam images. Computer subsystem 202 may be configured to perform any of the functions described herein using the output of the detector 207 and/or the electron beam images. Computer subsystem 202 may be configured to perform any additional step(s) described herein. A system 200 that includes the output acquisition subsystem shown in FIG. 6 may be further configured as described herein.

It is noted that FIG. 6 is provided herein to generally illustrate a configuration of an electron beam-based output acquisition subsystem that may be used in the embodiments described herein. The electron beam-based output acquisition subsystem configuration described herein may be altered to optimize the performance of the output acquisition subsystem as is normally performed when designing a commercial output acquisition system. In addition, the systems described herein may be implemented using an existing system (e.g., by adding functionality described herein to an existing system). For some such systems, the methods described herein may be provided as optional functionality of the system (e.g., in addition to other functionality of the system). Alternatively, the system described herein may be designed as a completely new system.

Although the output acquisition subsystem is described above as being an electron beam-based output acquisition subsystem, the output acquisition subsystem may be an ion beam-based output acquisition subsystem. Such an output acquisition subsystem may be configured as shown in FIG. 6 except that the electron beam source may be replaced with any suitable ion beam source known in the art. In addition, the output acquisition subsystem may be any other suitable ion beam-based output acquisition subsystem such as those included in commercially available focused ion beam (FIB) systems, helium ion microscopy (HIM) systems, and secondary ion mass spectroscopy (SIMS) systems.

The computer subsystem 202 includes a processor 208 and an electronic data storage unit 209. The processor 208 may include a microprocessor, a microcontroller, or other devices.

The computer subsystem 202 may be coupled to the components of the system 200 in any suitable manner (e.g., via one or more transmission media, which may include wired and/or wireless transmission media) such that the processor 208 can receive output. The processor 208 may be configured to perform a number of functions using the output. The wafer metrology tool can receive instructions or other information from the processor 208. The processor 208 and/or the electronic data storage unit 209 optionally may be in electronic communication with another wafer metrology tool, a wafer inspection tool, or a wafer review tool (not illustrated) to receive additional information or send instructions.

The processor 208 is in electronic communication with the wafer metrology tool, such as the detector 207. The processor 208 may be configured to process images generated using measurements from the detector 207. For example, the processor may perform embodiments of the method 100.

The computer subsystem 202, other system(s), or other subsystem(s) described herein may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 208 and electronic data storage unit 209 may be disposed in or otherwise part of the system 200 or another device. In an example, the processor 208 and electronic data storage unit 209 may be part of a standalone control unit or in a centralized quality control unit. Multiple processors 208 or electronic data storage units 209 may be used.

The processor 208 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 208 to implement various methods and functions may be stored in readable storage media, such as a memory in the electronic data storage unit 209 or other memory.

If the system 200 includes more than one computer subsystem 202, then the different subsystems may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 208 may be configured to perform a number of functions using the output of the system 200 or other output. For instance, the processor 208 may be configured to send the output to an electronic data storage unit 209 or another storage medium. The processor 208 may be further configured as described herein.

The processor 208 or computer subsystem 202 may be part of a defect review system, an inspection system, a metrology system, or some other type of system. Thus, the embodiments disclosed herein describe some configurations that can be tailored in a number of manners for systems having different capabilities that are more or less suitable for different applications.

The processor 208 may be configured according to any of the embodiments described herein, including the method 100. The processor 208 also may be configured to perform other functions or additional steps using the output of the system 200 or using images or data from other sources.

The processor 208 may be communicatively coupled to any of the various components or sub-systems of system 200 in any manner known in the art. Moreover, the processor 208 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 208 and other subsystems of the system 200 or systems external to system 200.

Various steps, functions, and/or operations of system 200 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random access memory, a magnetic or optical disk, a non-volatile memory, a solid state memory, a magnetic tape, and the like. A carrier medium may include a transmission medium such as a wire, cable, or wireless transmission link. For instance, the various steps described throughout the present disclosure may be carried out by a single processor 208 (or computer subsystem 202) or, alternatively, multiple processors 208 (or multiple computer subsystems 202). Moreover, different sub-systems of the system 200 may include one or more computing or logic systems. Therefore, the above description should not be interpreted as a limitation on the present disclosure but merely an illustration.

An additional embodiment relates to a non-transitory computer-readable medium storing program instructions executable on a controller for performing a computer-implemented method, as disclosed herein. In particular, as shown in FIG. 6, electronic data storage unit 209 or other storage medium may contain non-transitory computer-readable medium that includes program instructions executable on the processor 208. The computer-implemented method may include any step(s) of any method(s) described herein, including method 100.

As used herein, the term “workpiece” generally refers to substrates formed of a semiconductor or non-semiconductor material (e.g., a semiconductor wafer). Examples of such a semiconductor or non-semiconductor material include, but are not limited to, monocrystalline silicon, gallium nitride, gallium arsenide, indium phosphide, sapphire, and glass. Such substrates may be commonly found and/or processed in semiconductor fabrication facilities.

A workpiece may include one or more layers formed upon a substrate. For example, such layers may include, but are not limited to, a photoresist, a dielectric material, a conductive material, and a semiconductive material. Many different types of such layers are known in the art, and the term workpiece as used herein is intended to encompass a workpiece including all types of such layers.

One or more layers formed on a workpiece may be patterned or unpatterned. For example, a workpiece may include a plurality of dies, each having repeatable patterned features or periodic structures. Formation and processing of such layers of material may ultimately result in completed devices. Many different types of devices may be formed on a workpiece, and the term workpiece as used herein is intended to encompass a workpiece on which any type of device known in the art is being fabricated.

Other types of workpiece also may be used. For example, the workpiece may be used to manufacture LEDs, solar cells, magnetic discs, flat panels, or polished plates. Defects on other objects also may be classified using techniques and systems disclosed herein.

Each of the steps of the method may be performed as described herein. The methods also may include any other step(s) that can be performed by the processor and/or computer subsystem(s) or system(s) described herein. The steps can be performed by one or more computer systems, which may be configured according to any of the embodiments described herein. In addition, the methods described above may be performed by any of the system embodiments described herein.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A method comprising:
receiving, at a processor, a profile of a feature on an image of a workpiece generated using an electron beam metrology tool, wherein the feature is less than an entirety of the workpiece;
applying a Gaussian transfer function to the profile using the processor thereby generating an output profile; and
determining non-linearity of the output profile using the processor.

2. The method of claim 1, further comprising using the electron beam metrology tool to image the workpiece and generate the image.

3. The method of claim 1, wherein the electron beam metrology tool is a scanning electron microscope.

4. The method of claim 1, wherein the workpiece is a semiconductor wafer.

5. The method of claim 1, wherein the determining includes comparing the adjusted profile a baseline.

6. The method of claim 1, wherein the determining includes:
selecting two threshold values;
plotting the two threshold values on an XY plane; and
determining proximity of a slope of the threshold values to a comparison value, wherein the comparison value is equal to one.

7. The method of claim 6, further comprising increasing Gaussian blur in the image to increase correlation between the slope and the comparison value.

8. The method of claim 6, further comprising reducing Gaussian blur in the image to increase the proximity.

9. A non-transitory computer readable medium storing a program configured to instruct the processor to execute the method of claim 1.

10. A non-transitory computer readable medium storing a program configured to instruct the processor to execute the method of claim 6.

11. An electron beam metrology tool comprising:
an electron beam source that generates an electron beam;
a stage configured to hold a workpiece in a path of the electron beam;
a detector that receives electrons from the workpiece; and
a processor in electronic communication with the detector, wherein the processor is configured to:
generate an image of a feature on the workpiece using information from the detector, wherein the feature is less than an entirety of the workpiece;
generate a profile of the feature in the image;
apply a Gaussian transfer function to the profile thereby generating an output profile; and
determine non-linearity of the output profile.

12. The electron beam metrology tool of claim 11, wherein the electron beam metrology tool is a scanning electron microscope.

13. The electron beam metrology tool of claim 11, wherein the workpiece is a semiconductor wafer.

14. The electron beam metrology tool of claim 11, wherein determining the non-linearity includes comparing the adjusted profile a baseline.

15. The electron beam metrology tool of claim 11, wherein determining the non-linearity includes:
selecting two threshold values;
plotting the two threshold values on an XY plane; and
determining proximity of a slope of the threshold values to a comparison value, wherein the comparison value is equal to one.

16. The electron beam metrology tool of claim 15, wherein the processor is further configured to send instructions to increase Gaussian blur in the image to increase correlation between the slope and the comparison value.

17. The electron beam metrology tool of claim 15, wherein the processor is further configured to send instructions to reduce Gaussian blur in the image to increase the proximity.
